(19) United States
(12) Patent Application Publication
(10) Pub. No.: US 2007/0237353 A1
(43) Pub. Date: Oct. 11, 2007

(54) Magnetically tapered air gap for electromagnetic transducer

(76) Inventors: Enrique M. Stiles, Imperial Beach, CA (US); Richard C. Calderwood, Portland, OR (US)

Correspondence Address: RICHARD C. CALDERWOOD, 2775 NW 126TH AVE, PORTLAND, OR, 97229-8381, US

(21) Appl. No.: 11/401,535

(22) Filed: Apr. 10, 2006

(51) Int. Cl. H04R 11/02; H04R 9/06; H04R 1/00

(52) U.S. Cl. 381/418; 381/420; 381/412

(57) ABSTRACT

An electromagnetic transducer, such as an audio loudspeaker, having an underhung voice coil disposed in a magnetically tapered air gap. The taper provides asymmetry in the magnetic flux field. As the voice coil moves in one direction, the motor becomes stronger and more efficient, and as the voice coil moves in the other direction, the motor becomes weaker and less efficient. This results in an increase in even-order harmonics. The magnetic taper may result from a geometric taper of one or both of the opposing steel pieces which form the gap, or it may result from one or both of them having an at least partially laminated structure. The geometric taper provides a magnetic reluctance gradient along the height of the magnetic air gap. The laminated structure provides a magnetic reluctance gradient through the thickness of the laminated member (e.g. top plate). The magnetic reluctance gradient produces a magnetic flux density gradient along the height of the magnetic air gap.

### RELATED APPLICATIONS

This application is a divisional application of simultaneously-filed application ______ “Magnetically Tapered Air Gap for Electromagnetic Transducer”, which is a continuation-in-part of application Ser. No. 11/114,737 “Semi-Radially-Charged Conical Magnet for Electromagnetic Transducer” filed Apr. 25, 2005 by Enrique M. Stiles. All are commonly assigned to STEP Technologies, Inc.

### BACKGROUND OF THE INVENTION

1. Technical Field of the Invention

This invention relates generally to electromagnetic transducers, and more specifically to the shape of the flux distribution within the magnetic air gap in a loudspeaker motor structure.

2. Background Art

Conventional wisdom has been that it is desirable to provide as much symmetry as possible in the movement and force of the diaphragm assembly of a loudspeaker, to reduce distortion of the sound produced by variation in such characteristics. Loudspeaker designers have made significant efforts to ensure not only symmetric characteristics on either side of an at-rest center position, but also to ensure constant characteristics within a predetermined range of motion. A variety of techniques have been employed, such as overhung voice coils, underhung voice coils, extended polepieces, T-shaped polepieces, and so forth.

One area in which much of this effort has been spent has been in improving the symmetry of the magnetic flux field above and below the center position of the magnetic air gap.

One of the hallmarks of low performance, low cost loudspeakers has been minor variation in the geometry and symmetry of their motors.

Applicant's observation is that these symmetry efforts can actually be counterproductive, and that a markedly asymmetrical motor (as differentiated from a merely poorly designed “symmetrical” motor) will, in many applications, produce more pleasing sound.

### BRIEF DESCRIPTION OF THE DRAWINGS

FIG. 1 shows a loudspeaker having a tapered magnetic air gap according to one embodiment of this invention, in which the taper is provided by the top plate.

FIG. 2 shows a loudspeaker in which the aluminum basket extends into the tapered gap to serve as a highly effective shorting ring and thermal extraction heatsink.

FIG. 3 shows a loudspeaker having a tapered gap provided by the polepiece.

FIG. 4 shows a loudspeaker in which the tapered gap is provided by both the polepiece and the top plate.

FIG. 5 shows a loudspeaker in which the taper of the gap is not linear.

FIG. 6 shows a loudspeaker having a dual gap motor structure with tapered gaps.

FIG. 7 shows a loudspeaker having a gap tapered in the opposite direction to that shown in earlier drawings.

FIG. 8 shows an internal magnet geometry loudspeaker having a tapered gap.

FIG. 9 shows a partially exploded view of a transducer motor having a tapered gap in which the magnetic taper is created by a plurality of angled grooves in the top plate.

FIG. 10 shows a partially exploded view of a transducer motor having a tapered gap in which the magnetic taper is created by a plurality of radial grooves in the top plate and/or the pole piece.

FIG. 11 shows a tapered gap transducer motor using a semi-radially-charged conical magnet.

FIG. 12 shows magnetic FEA results of an exemplary transducer having a conventional, non-tapered gap.

FIG. 13 shows a Bn plot of the magnetic flux along the magnetic air gap of that transducer.

FIG. 14 shows magnetic FEA results of a transducer having a magnetically tapered gap in which the taper is created by a geometric taper in the top plate.

FIG. 15 shows a Bn plot of the magnetic flux along the magnetic air gap of that transducer.

FIG. 16 shows magnetic FEA results of a transducer having a magnetically tapered gap in which the taper is created by the top plate comprising a laminated structure of alternating sheets of steel and non-magnetically conductive material such as aluminum, copper, or plastic.

FIG. 17 shows a Bn plot of the magnetic flux along the magnetic air gap of that transducer.

FIG. 18 shows magnetic FEA results of a transducer having a magnetically tapered gap in which the laminated top plate assembly is tapered on the opposite edge to reduce mass.

FIG. 19 shows a Bn plot of the magnetic flux along the magnetic air gap of that transducer.

FIG. 20 shows magnetic FEA results of a transducer in which the laminated top plate uses steel layers of varying thickness.

FIG. 21 shows a Bn plot of the magnetic flux along the magnetic air gap of that transducer.

FIG. 22 shows magnetic FEA results of a transducer having a magnetically tapered gap in which the taper is created by both the top plate and the gap-forming portion of the polepiece each comprising laminated structures of alternating sheets of steel and aluminum.

FIG. 23 shows a Bn plot of the magnetic flux along the magnetic air gap of that transducer.

FIG. 24 shows magnetic FEA results of a transducer having a magnetically tapered gap in which the layers of steel and aluminum are of different thicknesses. It also shows having an axial offset between opposing layers of aluminum (or steel) in the top plate and the polepiece.

FIG. 25 shows a Bn plot of the magnetic flux along the magnetic air gap of that transducer.

FIG. 26 shows magnetic FEA results of a transducer having a magnetically tapered gap in which the laminated top plate is augmented with a thin cylinder of steel at the gap, which helps to smooth the magnetic taper along the gap.

FIG. 27 shows a Bn plot of the magnetic flux along the magnetic air gap of that transducer.

FIG. 28 shows magnetic FEA results of a transducer having a magnetically tapered gap formed with a conical, radially-charged magnet and a conical top plate.

FIG. 29 shows a Bn plot of the magnetic flux along the magnetic air gap of that transducer.

FIG. 30 shows a loudspeaker having an internal magnet geometry motor with a laminated top plate forming a magnetically tapered gap.

FIG. 31 shows magnetic FEA results of a transducer substantially similar to that of FIG. 30, and

FIG. 32 shows its Bn plot.

FIG. 33 shows an internal magnet geometry motor with a partially laminated top plate forming a magnetically tapered gap.

FIG. 34 shows magnetic FEA results of a motor substantially similar to that of FIG. 33, and

FIG. 35 shows its Bn plot.

FIG. 36 shows an internal magnet geometry motor with a partially laminated top plate forming a magnetically tapered gap, in which the top plate is less laminated than that of FIG. 33.

FIG. 37 shows magnetic FEA results of a motor substantially similar to that of FIG. 36, and

FIG. 38 shows its Bn plot.

FIG. 39 shows an internal magnet geometry motor with a partially laminated top plate forming a magnetically tapered gap, in which the laminated top plate includes magnets in its laminated structure.

FIG. 40 shows magnetic FEA results of a motor substantially similar to that of FIG. 39, and

FIG. 41 shows its Bn plot.

FIG. 42 shows an internal magnet geometry motor with a partially laminated top plate forming a magnetically tapered gap, in which the laminated top plate is held together with a steel bolt.

FIG. 43 shows magnetic FEA results of a transducer motor structure which has a magnetically tapered gap, and which uses an air return geometry flux circuit.

FIG. 44 shows a Bn plot of the magnetic flux along the height of the high flux density region where the voice coil will travel.

FIG. 45 shows magnetic FEA results of a transducer motor structure which has a partial cup which splits the difference between an air return geometry and a conventional internal magnet geometry, and which has a magnetically tapered gap.

FIG. 46 shows its Bn plot.

FIG. 47 shows magnetic FEA results of a transducer motor structure which includes a replaceable taper sleeve.

FIG. 48 shows its Bn plot.

FIG. 49 shows magnetic FEA results of the transducer motor structure of FIG. 47 with a different replaceable taper sleeve and the same other components.

FIG. 50 shows its Bn plot.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

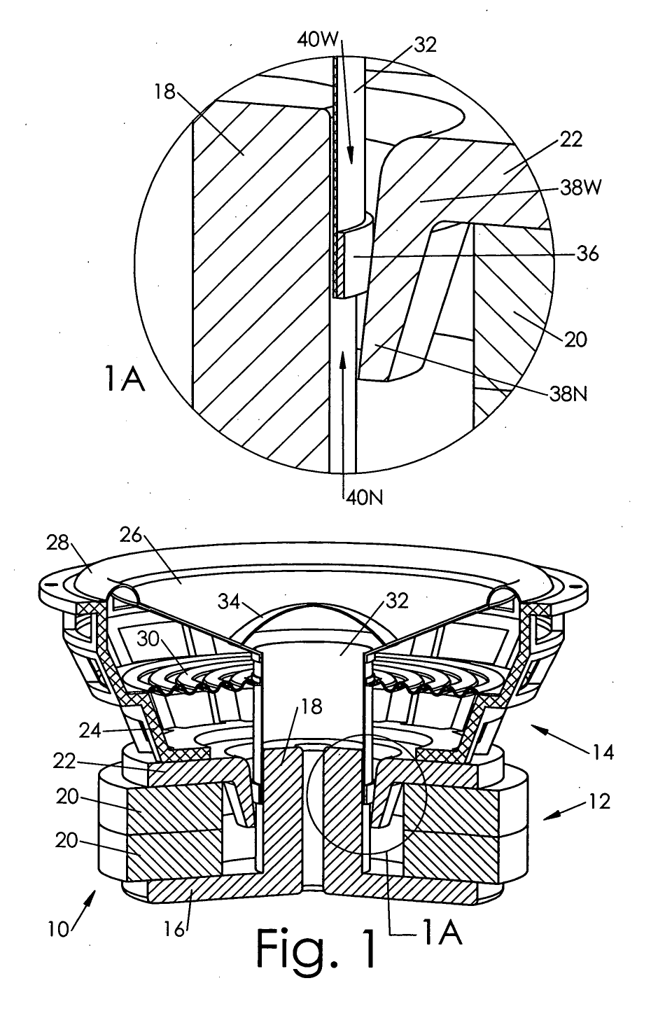

FIG. 1 illustrates a loudspeaker 10 according to one embodiment of this invention. The loudspeaker includes a motor structure 12 coupled to a diaphragm assembly 14. The motor structure may have any suitable configuration, and is shown here as having an external magnet geometry. In this configuration, the motor structure includes a poleplate including a back plate 16 and a polepiece 18. One or more magnets 20 are magnetically coupled between the back plate and a top plate 22. The diaphragm assembly is coupled to the motor structure by a frame 24. A diaphragm or cone 26 is coupled to the frame by a flexible surround 28. A bobbin 32 is coupled to the diaphragm. A flexible spider 30 couples the bobbin or the diaphragm to the frame. A dust cap 34 seals the front side of the diaphragm.

A voice coil 36 is coupled to the bobbin. Preferably, but not necessarily, the voice coil is underhung. The top plate includes an extension 38 which forms the magnetic air gap 40 with the pole piece. In one embodiment, the extension is formed by stamping the top plate. The extension includes a first portion 38N which extends closer to the polepiece than does a second portion 38W. The angle of the extension results in a geometrically tapered magnetic air gap which has a strong or “narrow” portion 40N and a weak or “wide” portion 40W.

The angle and dimensions of the taper can be selected by the loudspeaker designer according to the needs of a target application. The narrow portion of the magnetic air gap has a lower magnetic reluctance than does the wide portion of the magnetic air gap, and the magnetic flux field will be denser—stronger—in the narrow portion of the gap. As the voice coil moves toward the narrow end of the gap, the motor will become more powerful and more efficient. As the voice coil moves toward the wide end of the gap, the motor will become less powerful and less efficient. This asymmetry will tend to result in an increase in even-order harmonics in the resulting sound output. It is generally accepted that even-order harmonics are pleasing to the human ear, whereas odd-order harmonics sound harsh or dissonant.

For optimum effect, the voice coil should be underhung. If it were equalhung or overhung, there would much less change in BL as the voice coil moved axially in and out of the motor (as all available magnetic flux in the geometric gap would, at all positions within the geometric Xmax range, be passing through the voice coil, and only the fringe fields would cause the tapered effect). But with an underhung coil, the amount of magnetic flux passing through the voice coil changes as the voice coil moves from the narrow, strong end of the gap to the wide, weak end of the gap regardless of how small the excursion is, within the geometric Xmax range.

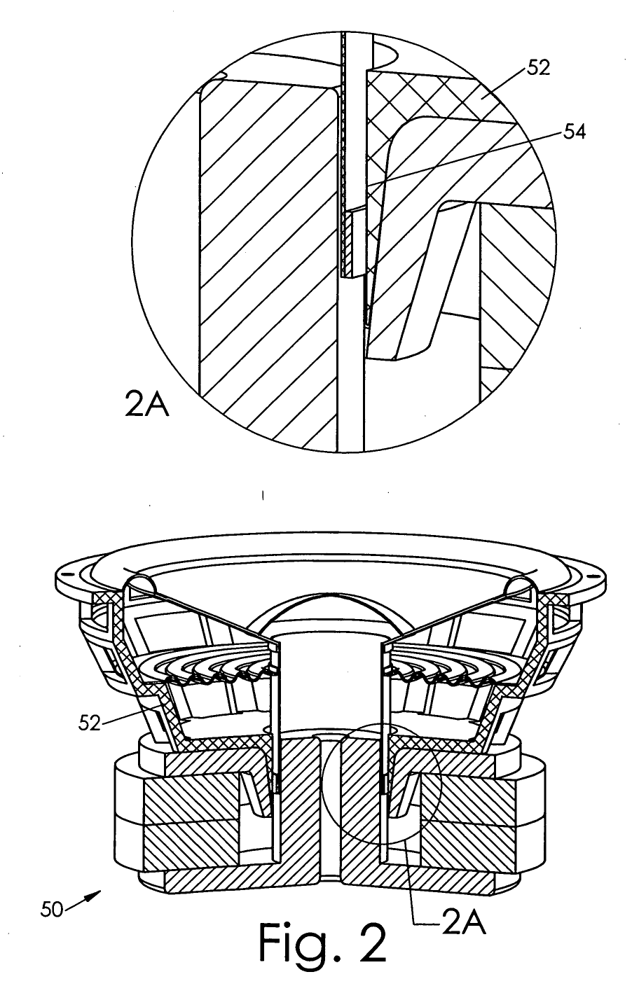

FIG. 2 illustrates a similar loudspeaker 50 in which the frame 52 includes a shorting ring portion 54 which extends into at least the wide end of the magnetic air gap, taking advantage of the increased clearance between the gap-forming portion of the top plate and the moving voice coil. The frame is made of a material which is electrically and/or thermally conductive, such as aluminum. The shorting ring portion sinks eddy currents which the voice coil's magnetic field would otherwise induce in the other, more electrically resistive, surrounding components such as the polepiece and top plate, reducing inductive heating of the motor structure. The frame further serves as a heat sink to extract heat away from the voice coil region of the motor structure, venting or dissipating the heat to the surrounding ambient air. In one embodiment, the shorting ring portion has a substantially cylindrical inner surface adjacent the voice coil.

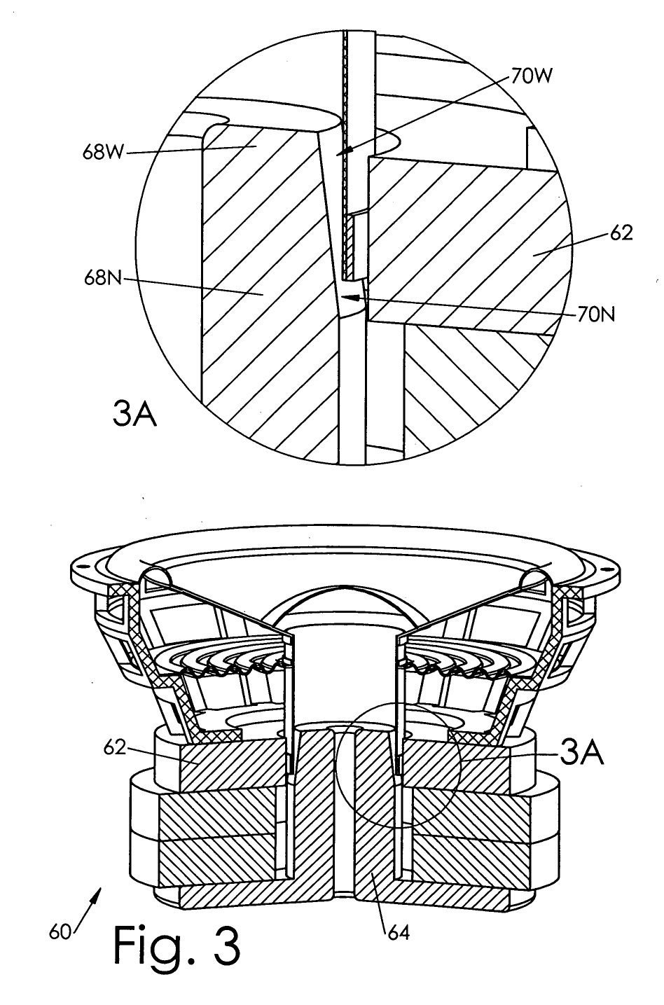

FIG. 3 illustrates a loudspeaker 60 according to another embodiment of this invention. The loudspeaker includes a conventional top plate 62 of sufficient axial thickness to make the voice coil underhung. The polepiece 64 includes a tapered region 68 adjacent the top plate, forming a tapered magnetic air gap 70. A first end 68W of this region of the polepiece provides a wide end 70W of the magnetic air gap, and a second end 68N of this region of the polepiece provides a narrow end 70N of the magnetic air gap. Advantageously, but not necessarily, the wide end of the magnetic air gap is at the uppermost end of the motor structure, as shown.

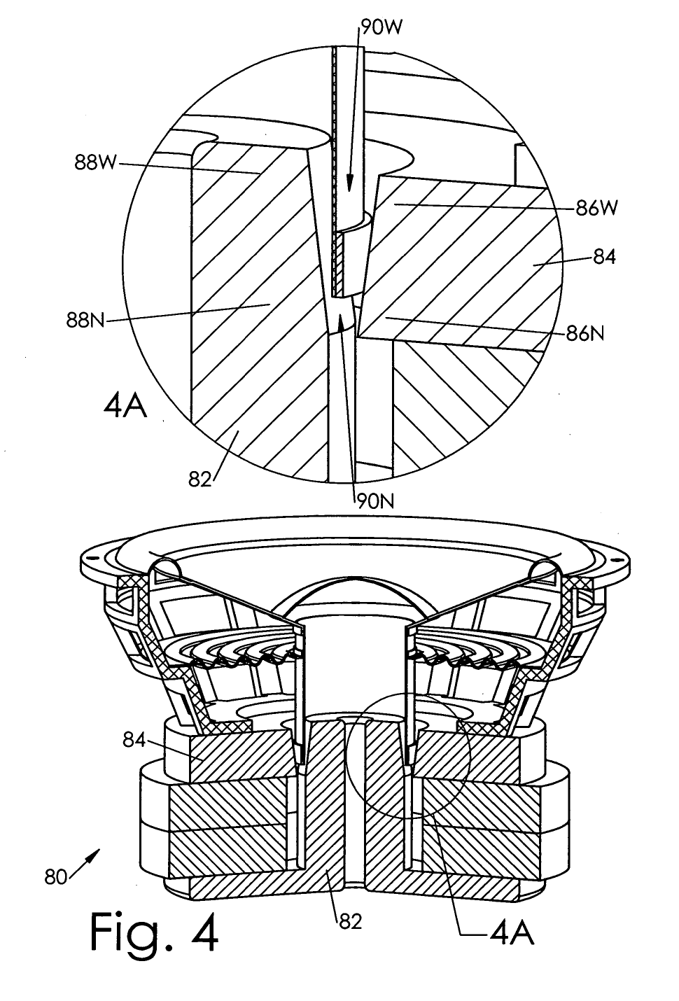

FIG. 4 illustrates a loudspeaker 80 in which both the polepiece 82 and the top plate 84 have tapered surfaces to jointly provide the tapered magnetic air gap 90. A first end 86W of the top plate and a first end 88W of the adjacent region of the polepiece define the wide end 90W of the magnetic air gap, and a second end 86N of the top plate and a second end 88N of the adjacent region of the polepiece define the narrow end 90N of the magnetic air gap.

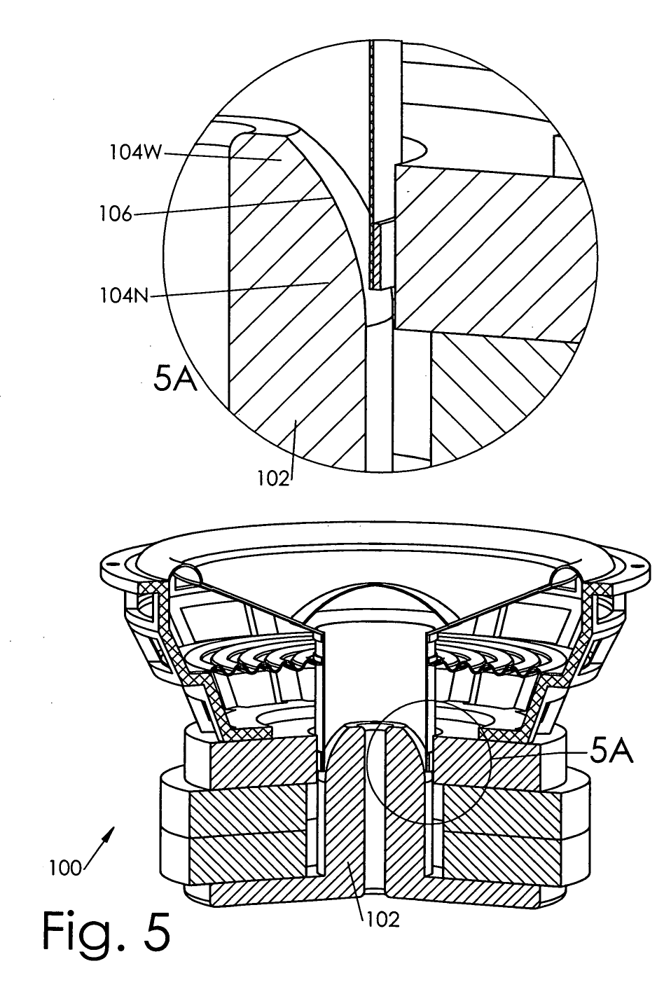

FIG. 5 illustrates a loudspeaker 100 in which the polepiece 102 provides a magnetic air gap whose taper is not strictly linear. In one such embodiment, the polepiece has a rounded end such that a lower end 104N of the rounded end defines the narrow end of the magnetic air gap, and an upper end 104W of the rounded end defines the wide end of the magnetic air gap. The rounded end of the polepiece has a curved profile 106.

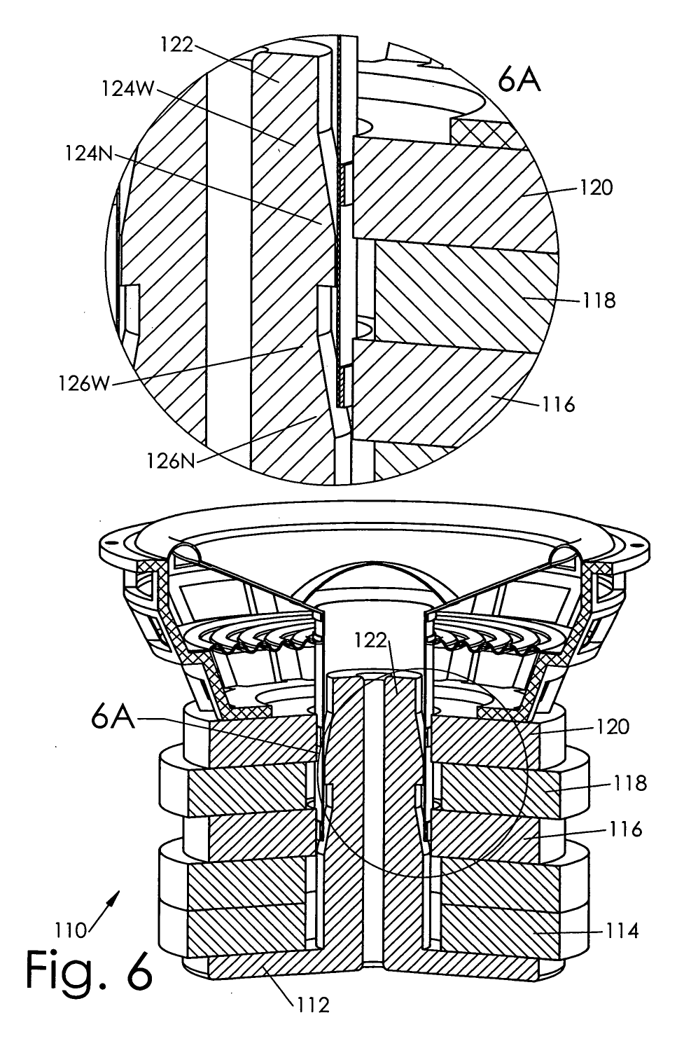

FIG. 6 illustrates a loudspeaker 110 having a dual gap motor geometry such as taught in U.S. Pat. No. 6,917,690. The motor structure includes a poleplate having a back plate 112 and a polepiece 122. One or more magnets 114 are magnetically coupled between the back plate and a lower top plate 116. Another magnet 118 is magnetically coupled between the lower top plate and an upper top plate 120. The magnets are polarized in the same axial direction. The two top plates define two magnetic air gaps with the polepiece. In one embodiment, the top plates provide the taper for both gaps; in another embodiment, one gap is tapered by its top plate, and the other gap is tapered by the polepiece. In yet another embodiment, both the pole and the plates are tapered. But in the embodiment shown, both gaps are tapered by the polepiece alone. The polepiece tapers from a first region 124W to a second region 124N to taper the upper magnetic air gap, and from a third region 126W to a fourth region 126N to taper the lower magnetic air gap. In still another embodiment, only one of the two gaps is tapered. Another embodiment combines a pair of tapered gaps with the dual-gap geometry taught in U.S. Pat. No. 6,917,690, with a single voice coil extending from the middle of one gap to the middle of the other; as the voice coil moves in one direction, it moves into the strong end of one gap as it moves out of the weak end of the other, and vice versa in the opposite direction.

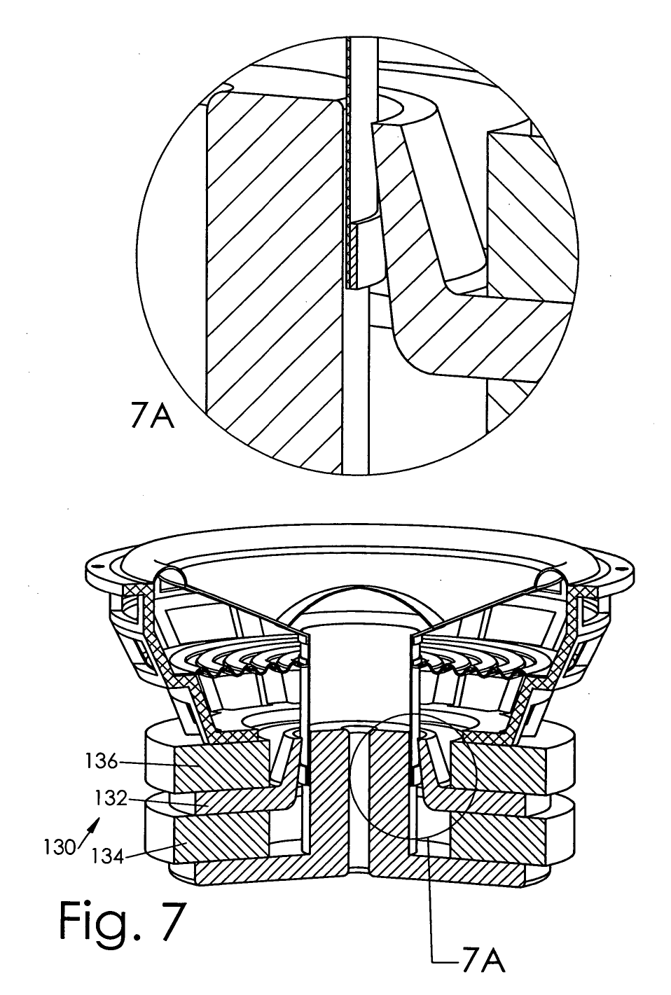

FIG. 7 illustrates a loudspeaker 130 similar to that of FIG. 1, except the top plate 132 extends outwardly from the motor rather than inwardly into the motor, and one of the magnets has been moved above the top plate and polarized in the opposite direction as the lower magnet. This configuration may prove useful in achieving a desired Bn profile in the gap, and may, depending on the magnets used, allow an increase in the flux density (by doubling the magnet surface area in contact with the top plate). This configuration may also permit the use of thinner or fewer magnets, and/or the use of a flat back plate rather than a bumped one.

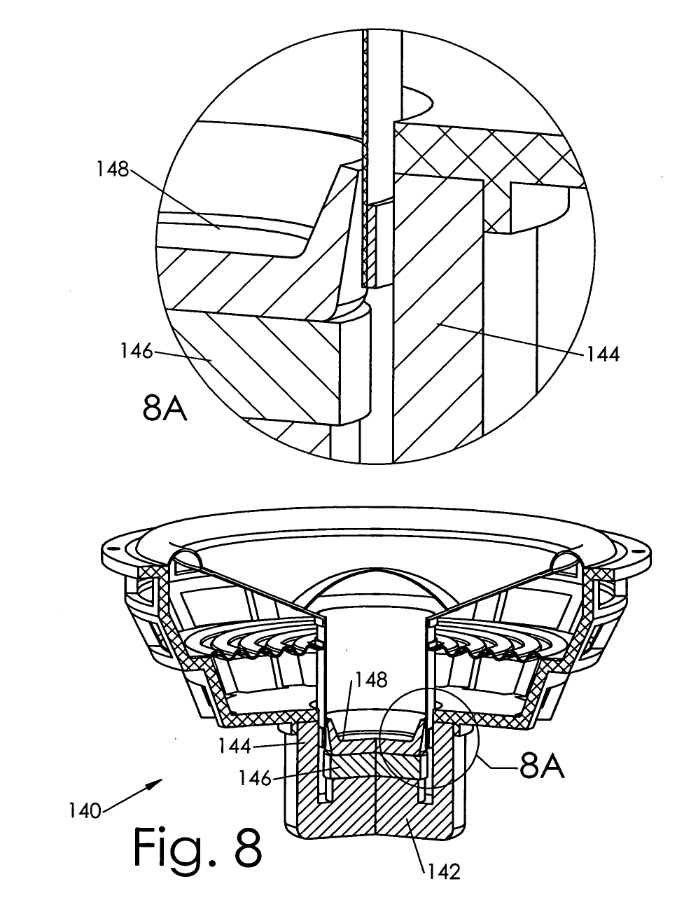

FIG. 8 illustrates a loudspeaker 140 having an internal magnet geometry motor. The motor includes a cup style yoke 142 having a cylindrical portion 144, an internal magnet 146, and an internal top plate 148 which defines the magnetic air gap with the cylindrical portion of the cup. In one embodiment, the OD face of the top plate is beveled, to produce the tapered gap.

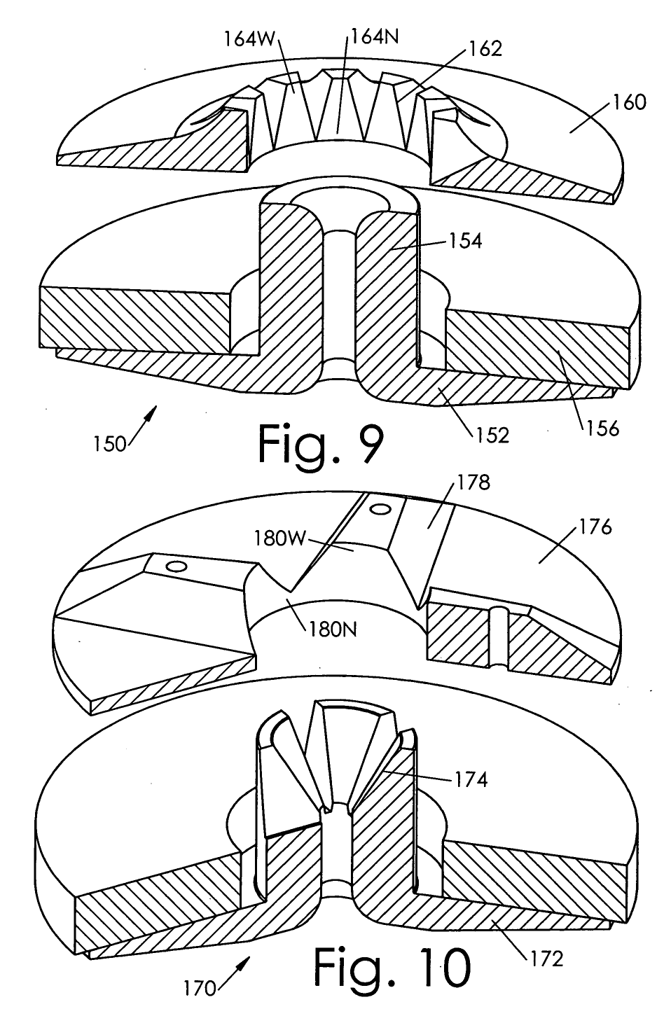

FIG. 9 illustrates a transducer motor 150 according to another embodiment of this invention. Previous figures have illustrated methods of producing a magnetically tapered gap by using motor component(s) whose gap-forming surface(s) are geometrically tapered such that the physical width of the magnetic air gap varies from one axial end of the gap to the other. FIG. 9 introduces one method of producing a magnetically tapered gap by using motor component(s) whose magnetic gap surface area varies from axial end of the gap to the other, thereby altering the circumferentially averaged flux density at different axial heights. (In other words, such that different flux densities pass through different segments of a particular voice coil winding at any given moment.)

The motor 150 includes a poleplate having a back plate 152 and a polepiece 154, one or more magnets 156, and a top plate 160. The motor is shown in partially exploded view, to give better visibility of the structure of the top plate. The top plate includes a plurality of diagonal wedge-shaped grooves 162 cut or otherwise formed into the gap-forming ID surface 164. This results in gap-forming faces having a narrow dimension at a “magnetically wide gap” end 164W of the top plate and having a wide dimension at a “magnetically narrow gap” end 164N of the top plate. Having less steel at the top end of the top plate will give that end a higher circumferentially averaged magnetic reluctance than the other end, which has more steel in close proximity to the polepiece. This will tend to concentrate the flux more at the bottom end of the gap. If the grooves are sufficiently extreme, they may even result in the upper end of the magnetic air gap being significantly non-axisymmetric, or not uniform around the polepiece.

In other words, some arc segments of the voice coil in the upper end of the magnetic air gap may find themselves in regions of even further reduced B field than their immediately adjacent arc segments. This further reduces BL in the “wide” end of the gap, exaggerating the taper. It may also cause magnetic saturation at the upper tips of the gap surface portions of the steel, which may lead to further acoustical benefits such as stabilization of distortions and the like.

FIG. 10 illustrates a transducer motor 170 having a pole plate including a back plate 172 and a polepiece 174, a magnet, and a top plate 176. The polepiece and/or the top plate are equipped with a plurality of radial notches which, ideally, have a beveled or “V” shape as shown. This has a similar effect as in FIG. 9, resulting in a tapered magnetic air gap.

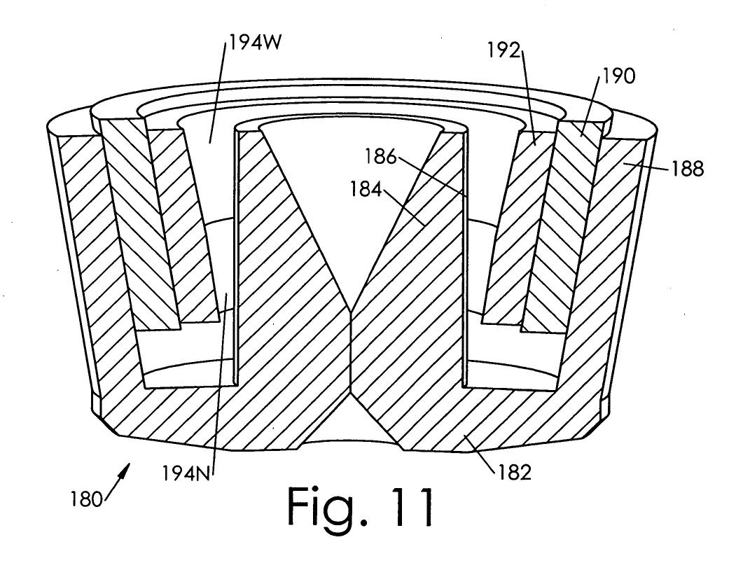

FIG. 11 illustrates a transducer motor 180 utilizing the principles taught in the co-pending application identified above. The motor includes a back plate 182 coupled to or integrally formed with a pole piece 184 and an outer conical member 188, and together these form a yoke. In one embodiment, the pole piece has a substantially cylindrical outer surface 186. A conical magnet 190, which is charged radially or semi-radially, has an outer surface which mates with the inner surface of the yoke's outer conical member. The inner surface of the magnet has a conical shape. A conical top plate 192 has an outer surface which mates with the inner surface of the magnet, and a conical inner surface which defines the tapered magnetic air gap with the pole piece. In another embodiment, the top plate is omitted and the conical inner surface of the magnet achieves the taper of the magnetic air gap.

### Magnetic Taper Analysis

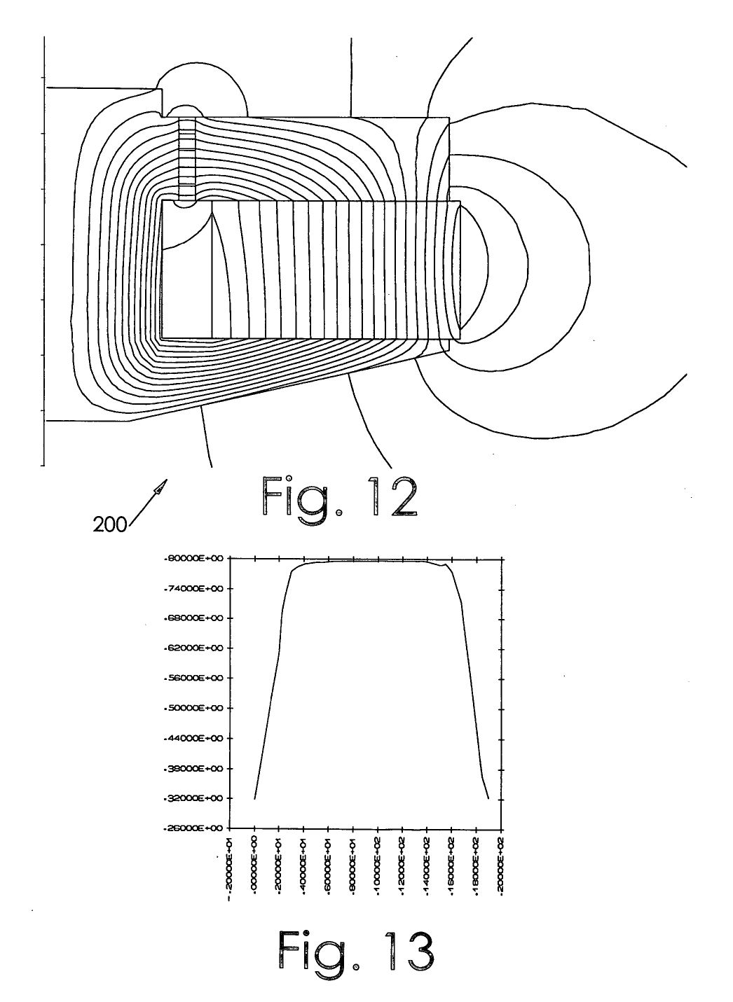

FIG. 12 is a flux plot showing magnetic finite element analysis (FEA) of an external magnet geometry transducer motor 200. The motor is modeled as an axisymmetric revolve around the left margin of the graph. The thin lines show the flow of the magnetic flux through the motor. The reader should ignore a set of seemingly superfluous horizontal lines in the magnetic air gap; those are used in the FEA model to cause the FEA program to place increased emphasis of accuracy in the area of the magnetic air gap, and do not represent actually physical structures.

FIG. 13 is a Bn (B field normal to the voice coil) graph showing the strength of the magnetic flux field along the height of the magnetic air gap of FIG. 12. FIG. 13 shows that the magnetic flux field has a very uniform strength (at about 0.79 Tesla) along the entire height of the magnetic air gap, and that it falls off rather quickly beyond either end of the gap.

The horizontal axis represents the vertical position as shown along the magnetic air gap, and the vertical axis represents magnetic flux field strength. It may help the reader to imagine rotating FIG. 12 to the right (clockwise) by 90° and then juxtaposing it with the magnetic air gap of FIG. 11.

The following flux and Bn charts should be interpreted similarly, and will not be cluttered with reference numbers.

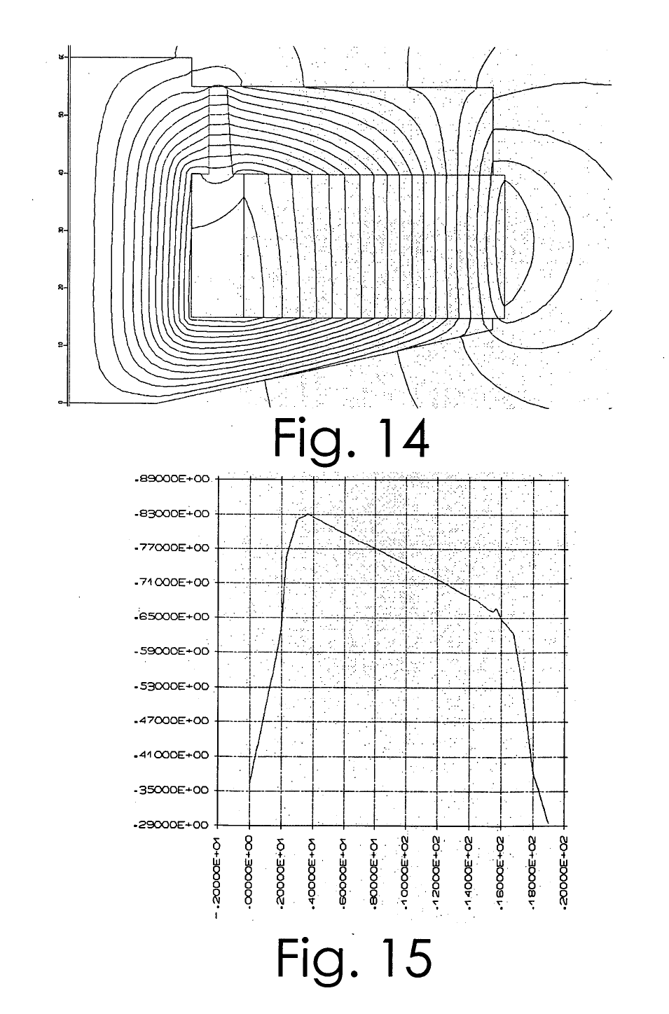

FIG. 14 is a flux plot showing magnetic FEA results of a transducer motor which is similar except that its top plate has a slightly tapered ID surface. The magnetic air gap is narrower (3 mm) at the top of the gap than at the bottom (4 mm).

FIG. 15 is a Bn graph showing the rather remarkable taper from about 0.83 Tesla at the top, narrow end of the gap to about 0.65 Tesla at the bottom, wide end of the gap. The slope of the taper is extremely linear.

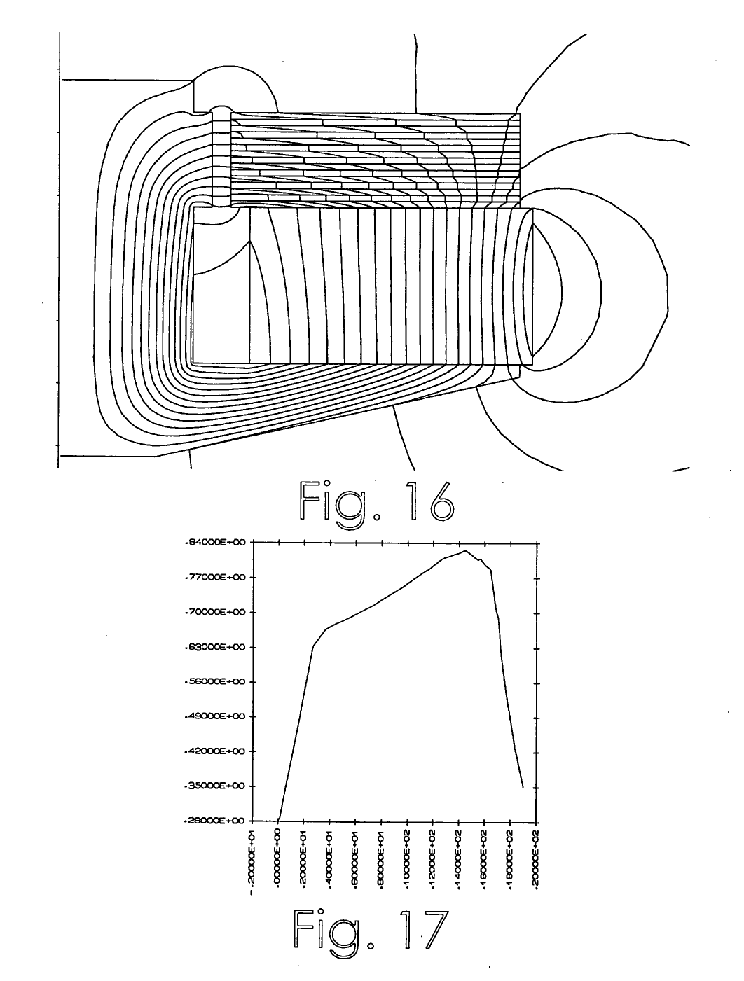

FIG. 16 is a flux plot showing magnetic FEA results of a transducer motor which uses the same poleplate and magnet as in FIGS. 12 and 14, but which achieves a magnetic taper in a completely different manner. The top plate is comprised of a laminated assembly of alternating layers of steel and aluminum (or other non magnetically conductive material). When the magnetic flux enters a steel layer, it will take the path of least reluctance, which will in most positions be radially toward the polepiece. But when the magnetic flux enters an aluminum layer, the path of least resistance is axially toward the next steel layer. The magnetic flux thus takes a “stairstep” path from the magnet to the magnetic air gap. The farther up the laminated top plate structure, the more total aluminum the flux must pass through to get from the magnet, and the higher the reluctance of that path. The result is that the magnetic air gap is strongest at its bottom end, and tapers off toward its top end.

A further advantage of the laminated structure is that the aluminum plates serve as electrically conductive shorting rings, to stabilize both magnetic flux modulation and inductive modulation and thereby reduce distortion, and to reduce induction heating of the motor, and further serve as thermally conductive paths for heat to escape radially out of the motor. In some embodiments, one or more of the aluminum layers may be formed with air passages therethrough to permit radial airflow, further cooling the motor. In some embodiments, some or all of the aluminum layers may be in contact with, or integrally formed with, a thin, cylindrical aluminum shorting ring in the gap and the intervening steel layers are not contiguous rings (to facilitate assembly). In some embodiments, one or more of the aluminum layers may be integrally formed with an aluminum basket which then serves as a large heatsink for cooling the motor.

FIG. 17 is a Bn graph showing the taper of the magnetic air gap of FIG. 16. Each of the steel layers of the laminated top plate in effect forms its own, short magnetic air sub-gap with the pole plate. Due to fringing effects between each of these sub-gaps, the net effect can be a substantially linear overall taper, as shown. The skilled transducer designer can, after obtaining the teachings of this disclosure, select steel layer thicknesses, aluminum layer thicknesses, etc. to achieve a desired taper in the magnetic air gap of the transducer being designed.

FIG. 18 is a flux plot showing magnetic FEA results of a transducer motor similar to that of FIG. 16, but in which the laminated top plate has been beveled at its OD to reduce its mass by eliminating metal that does not significantly contribute to the radially-inward carrying of the magnetic flux in the steel layers. In some embodiments, the aluminum spacers extend well beyond the OD of the steel plate, and thereby act as a more effective heatsink and radiator.

FIG. 19 is a Bn graph of the tapered magnetic air gap of FIG. 18.

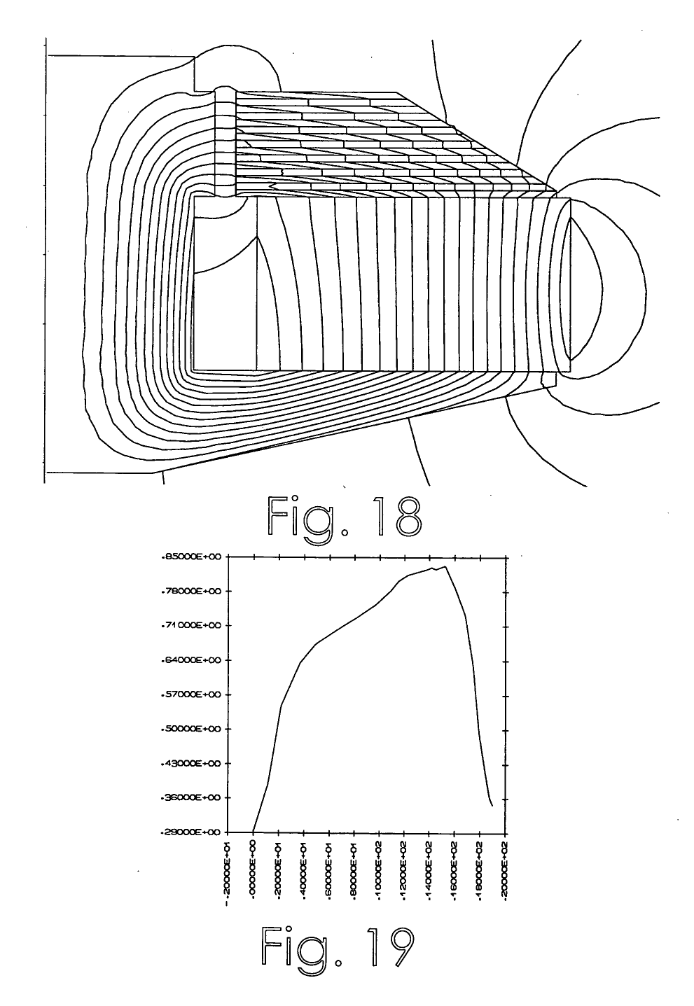

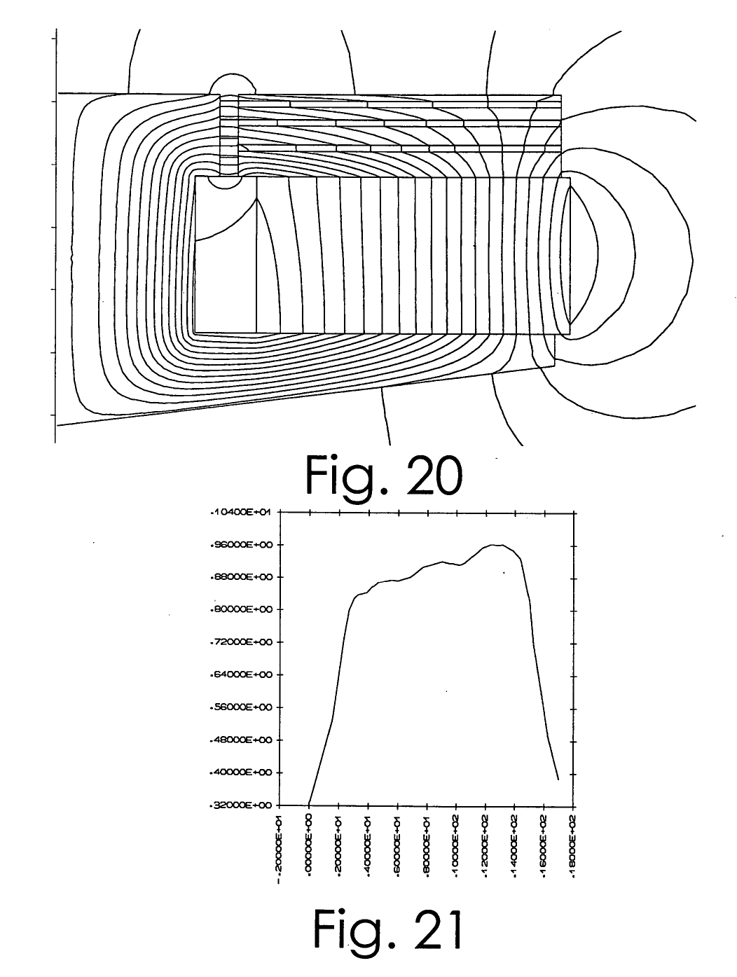

FIG. 20 is a flux plot showing magnetic FEA results of a transducer motor in which the laminated top plate uses steel layers of varying thickness. Additionally, or alternatively, the aluminum spacers may vary in thickness.

FIG. 21 is a Bn graph of the tapered magnetic air gap of FIG. 20. The relatively thick steel layers can be seen to produce a somewhat non-linear taper. In many applications, this will be something which the transducer designer will wish to minimize, although the potential effects of small variances will be averaged out by the voice coil's winding height.

FIG. 22 is a flux plot showing magnetic FEA results of a transducer motor in which both the top plate and the opposing, gap-forming portion of the poleplate are formed as laminated structures having alternating layers of ferromagnetic material (such as steel) and paramagnetic material (such as aluminum or copper) or, in some cases, diamagnetic material (such as plastic). In some embodiments, the top plate and this portion of the polepiece are of substantially identical construction such that opposing layers are of the same type of material, are of the same thickness, and are at the same axial position without offset. In other embodiments, the top plate and the gap-forming portion of the polepiece are not identical; one may use different numbers of layers, different thicknesses of layers, offset, etc. In one embodiment, the top plate is simply steel, and only the polepiece is laminated.

FIG. 23 is a Bn graph of the tapered magnetic air gap of FIG. 22, and shows the exaggerated taper which results from laminating both the top plate and the pole piece.

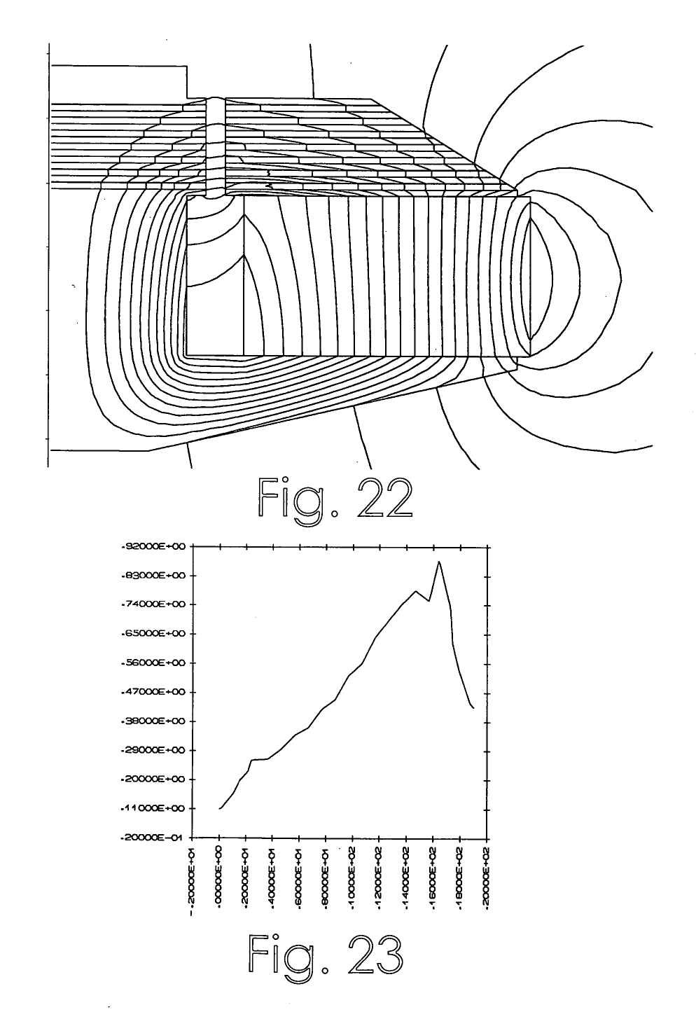

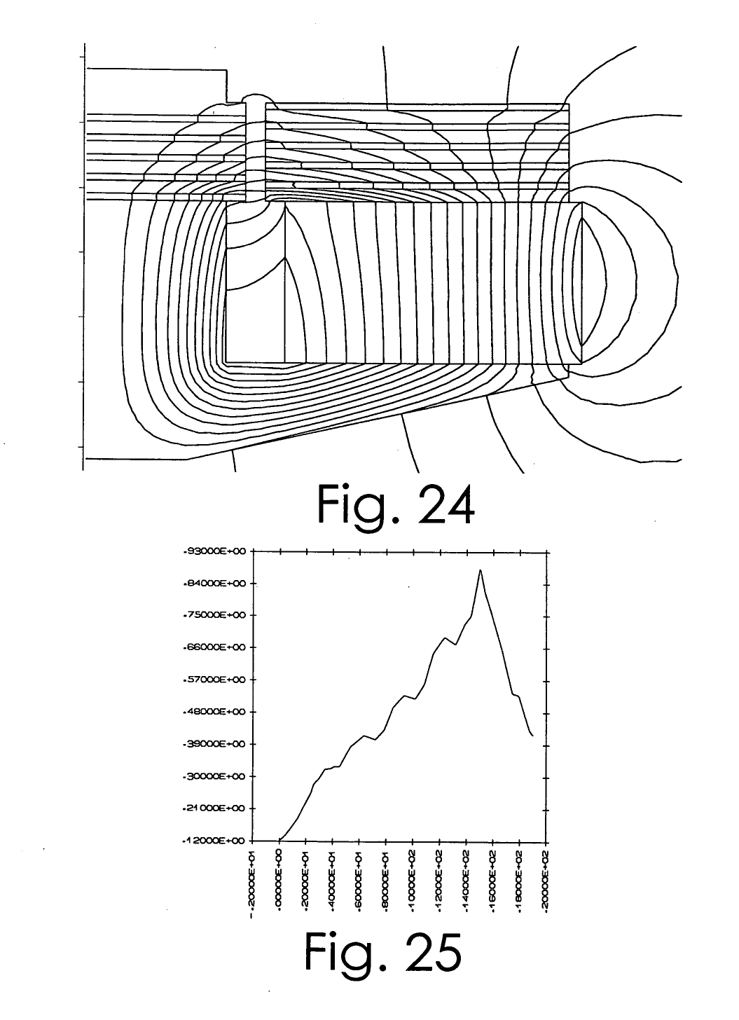

FIG. 24 is a flux plot showing magnetic FEA results of a transducer motor in which the laminated top plate and the laminated polepiece have offset, meaning that their steel layers are not directly opposite each other in the same axial positions.

FIG. 25 is a Bn graph of the tapered magnetic air gap of FIG. 24.

FIG. 26 is a flux plot showing magnetic FEA results of a transducer motor which is similar to that of FIG. 20, with the addition of a thin, cylindrical steel sleeve coupled at the ID of the pole piece. Because it is in direct or immediate contact with the steel layers, this sleeve serves to smooth the taper of the magnetic air gap. Its radial cross-sectional thickness needs to be selected appropriately. If it is too thick, it will swamp any tapering effect of the lamination.

FIG. 27 is a Bn graph of the tapered magnetic air gap of FIG. 26.

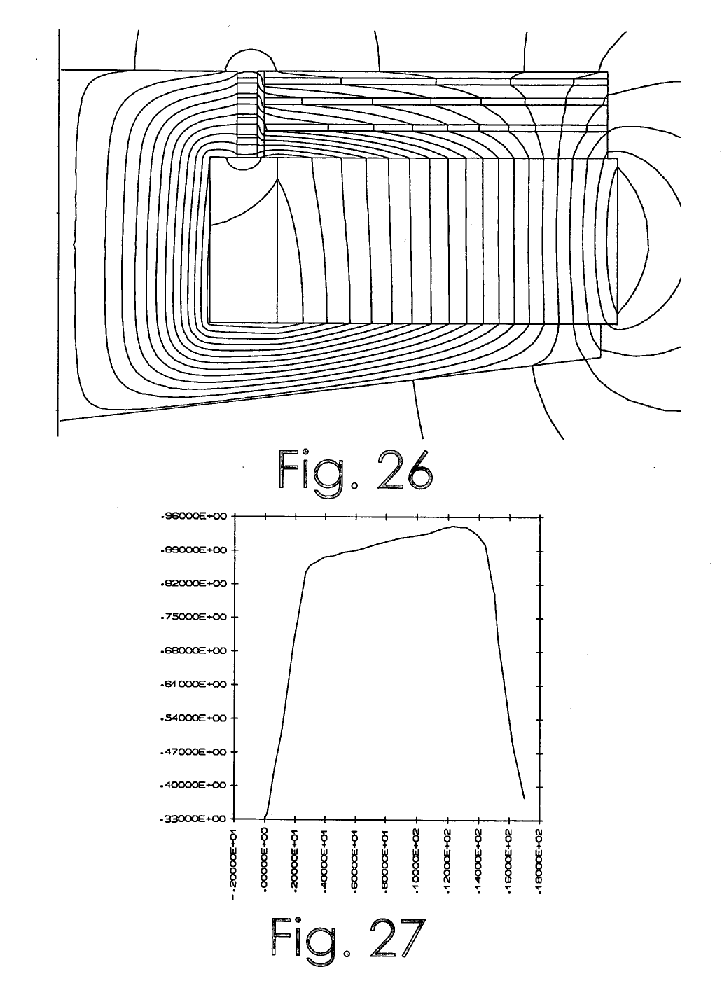

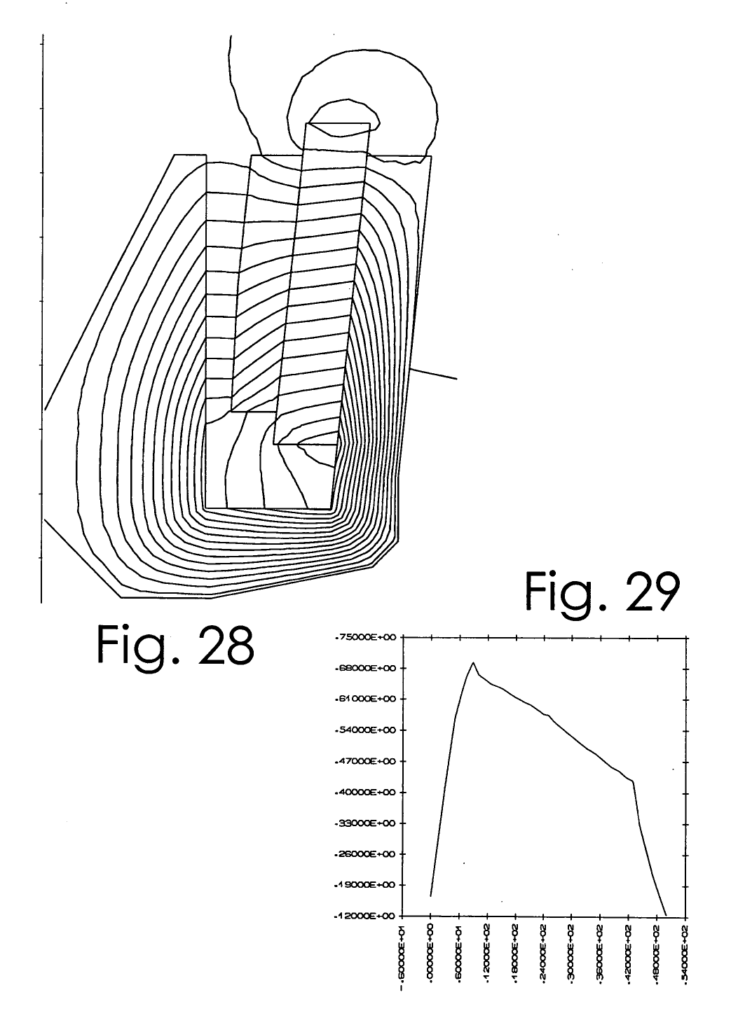

FIG. 28 is a flux plot showing magnetic FEA results of a transducer motor which is similar to that of FIG. 11, using a semi-radially-charged conical magnet and a conical top plate to achieve a tapered gap. In another embodiment, the top plate can be omitted, and the conical inner surface of the semi-radially-charged magnet accomplishes the taper by itself.

FIG. 29 is a Bn graph of the conical magnet motor of FIG. 28

### Additional Internal Magnet Embodiments

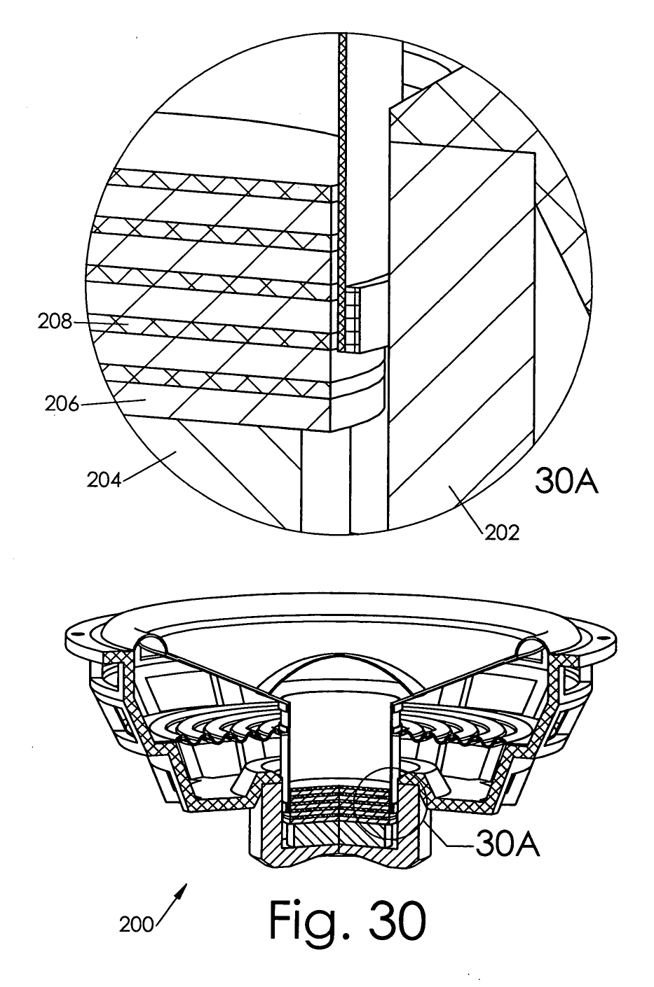

FIG. 30 illustrates a loudspeaker 200 having an internal magnet geometry motor in which a laminated top plate forms a magnetically tapered air gap. The motor includes a cup 202, a permanent magnet 204, and a laminated top plate formed of alternating steel plates 206 and aluminum plates 208.

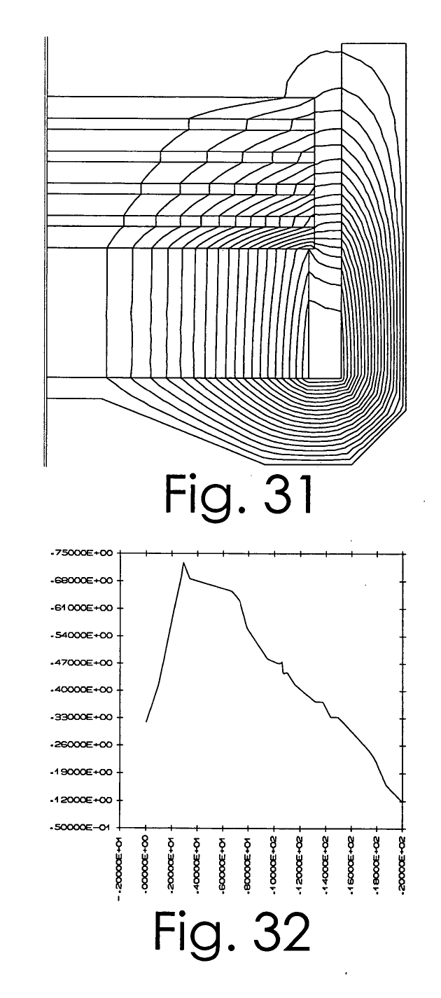

FIG. 31 is a flux plot showing magnetic FEA results of a motor which is similar to that of FIG. 30, and FIG. 32 is a Bn graph of the magnetically tapered air gap of FIG. 31. Minor irregularities in the Bn graphs are caused by node limitations in applicant's FEA software, and do not exactly represent the taper of the magnetic air gap. The air itself, being of the same reluctance at all positions along the magnetic air gap, will tend to smooth out any highly localized flux irregularities in the immediate vicinity of the OD of the laminated top plate.

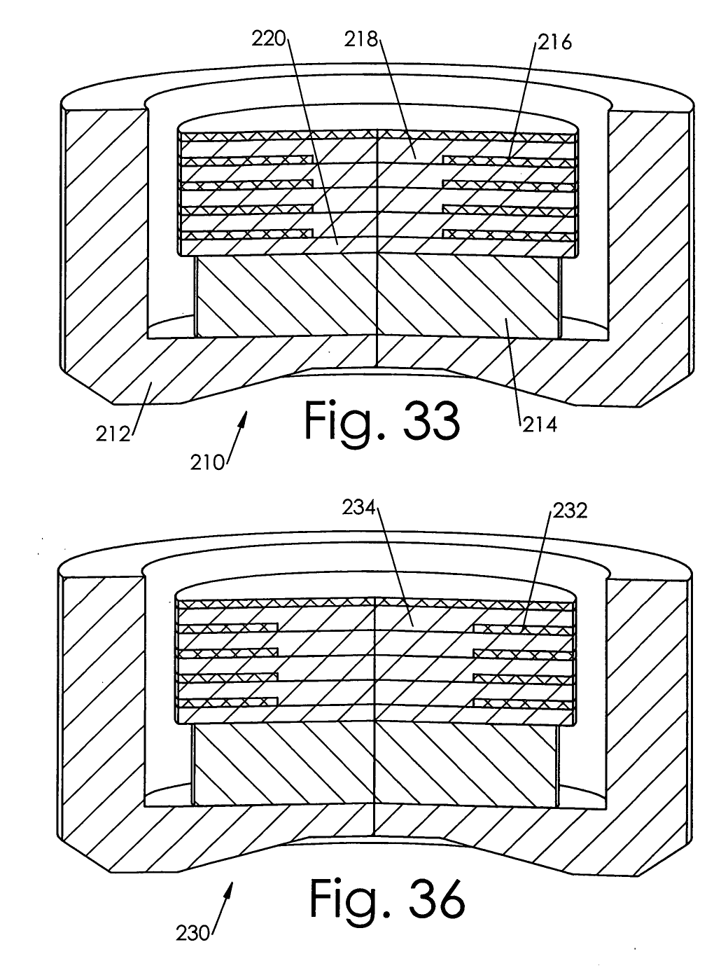

FIG. 33 illustrates an internal magnet geometry motor structure 210 including a cup 212, a permanent magnet 214, and a partially laminated top plate which forms a magnetically tapered air gap with the cup. The top plate is “partially laminated” in that, at some radial positions it includes layers of steel and aluminum, while at other radial positions, it includes only layers of steel. A top plate made solely of layers of steel would not produce any meaningful taper, as the steel layers would behave essentially as a single steel unit.

The partially laminated top plate includes one or more aluminum rings 216 each having one or more holes through their thickness (shown with only a single, axial hole) and one or more steel plates 218 each including one or more protruding portions which extend through the holes in the aluminum rings. Optionally, there may be one or more steel plates 220 which lack the protrusions. Optionally, the aluminum rings can be omitted and the magnetic air gap will still be tapered; however, they are desirable to act as flux stabilizing rings and eddy current sinks.

The non-laminated portion (e.g. the central core) of the laminated top plate can be formed, as shown, by steel protrusions on one side of the steel plates. Alternatively, these protrusions could be replaced by separate steel discs. Alternatively, the steel protrusions could be on both sides of some or all of the steel plates. It is desirable, but not strictly necessary, that the bottommost steel plate be fully flush with the magnet, to maximize magnetic coupling with the magnet and reduce the overall reluctance of the magnetic circuit.

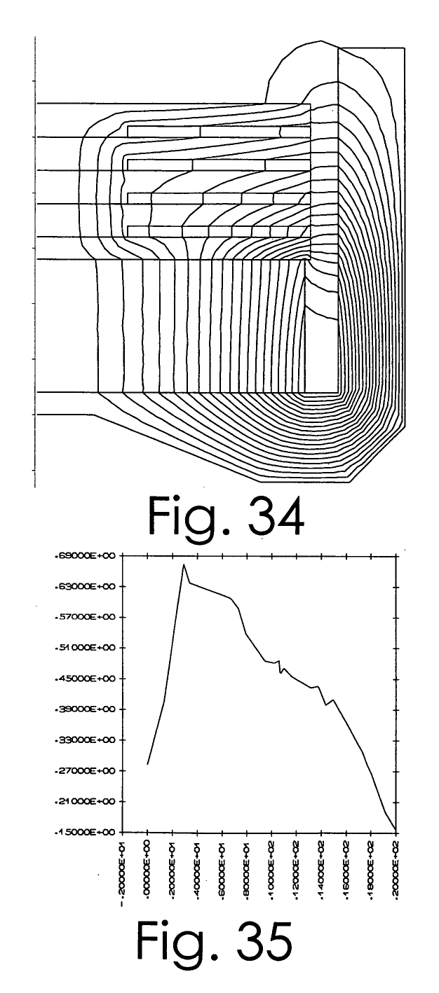

FIG. 34 is a flux plot showing magnetic FEA results of a motor which is similar to that of FIG. 33, and FIG. 35 is a Bn graph of the tapered magnetic air gap of FIG. 34. In the “geometric Xmax” region of the magnetic air gap, the FIG. 34 motor will have a somewhat less steep taper than the FIG. 31 motor, due to its partial lamination.

FIG. 36 illustrates an internal magnet geometry motor structure 230 which is similar to that of FIG. 33, except that the steel plates' protruding portions are larger (in diameter), such that it is “less laminated” than the FIG. 33 motor.

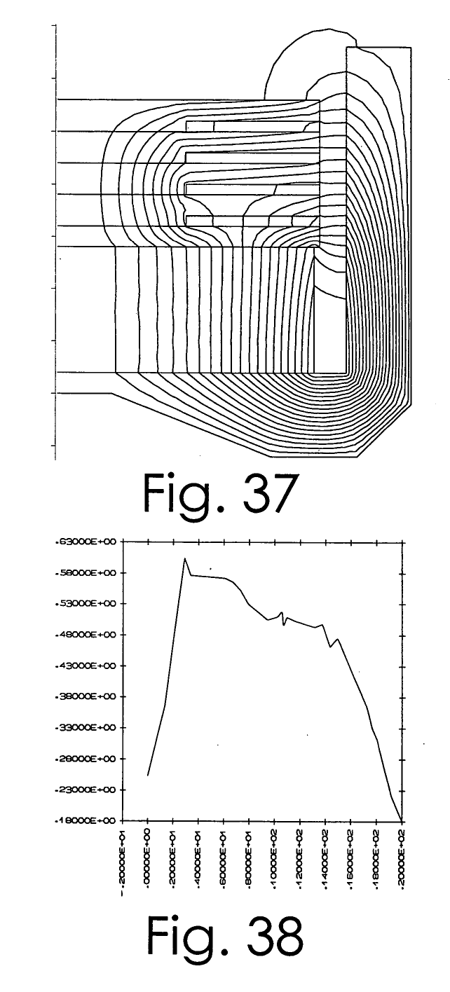

FIG. 37 is a flux plot showing magnetic FEA results of a motor which is similar to that of FIG. 36, and FIG. 38 is its Bn graph. As can be seen, the reduced lamination area results in a reduced taper.

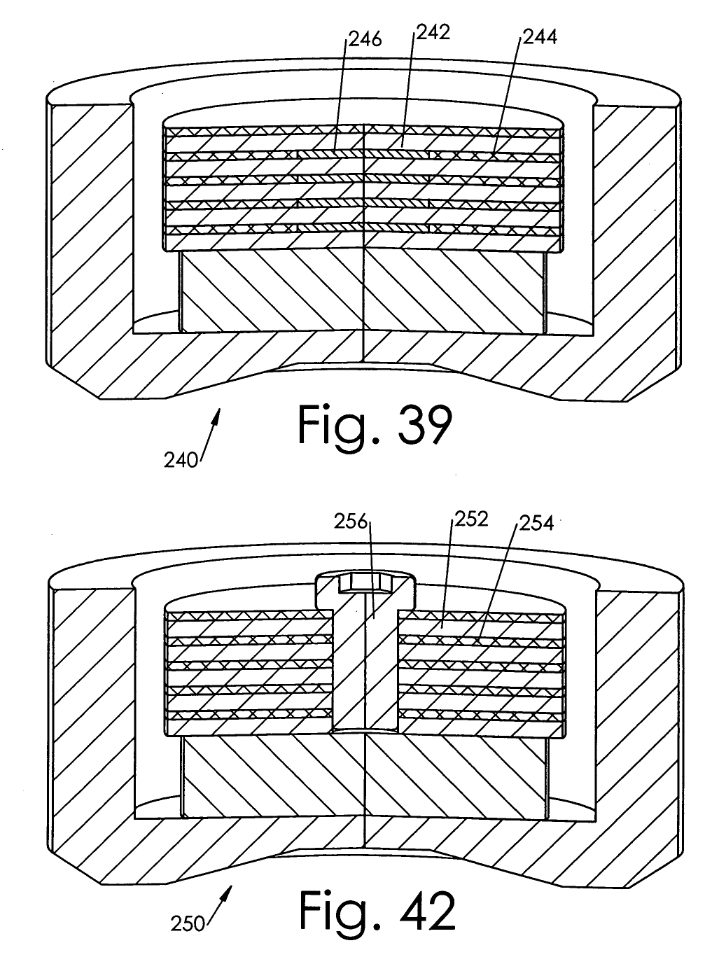

FIG. 39 illustrates an internal magnet geometry motor structure 240 in which, rather than the steel plates 242 being magnetically connected by protrusions which extend the thickness of the aluminum rings, the holes through the aluminum rings 244 are occupied by permanent magnets 246. Any number of the layers can be connected in this manner.

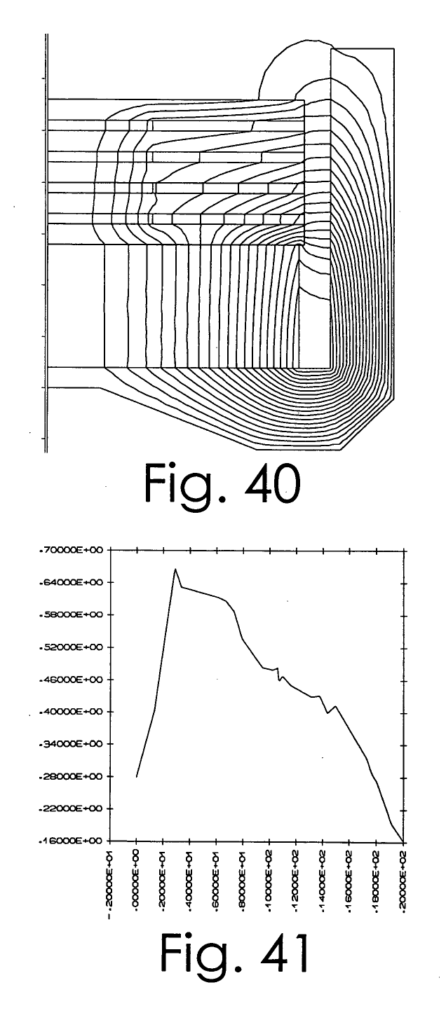

FIG. 40 is a flux plot showing magnetic FEA results of a motor which is similar to that of FIG. 39, and FIG. 41 is its Bn graph.

FIG. 42 illustrates an internal magnet geometry motor structure 250 in which the steel plates 252 and aluminum rings 254 of the laminated top plate are connected by a steel bolt 256. Magnetically, this motor behaves essentially like that of FIG. 33 (if the bolt has the same OD as the steel layers' protrusions). Mechanically, it can be made stronger and its layers kept in more secure coaxial alignment.

### Air Return Motor

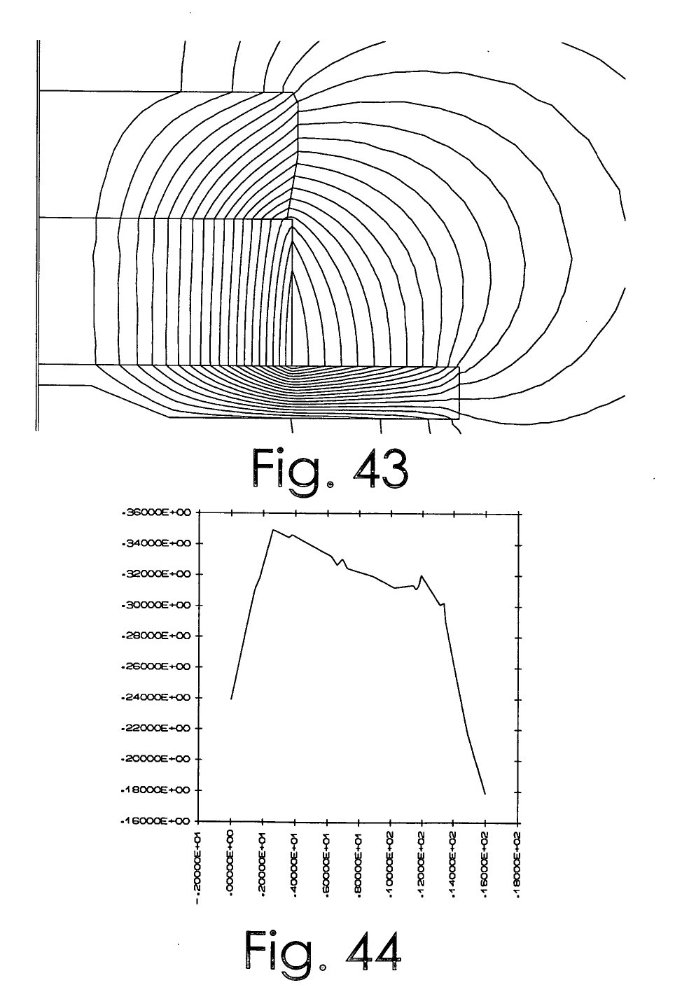

FIG. 43 is a flux plot showing magnetic FEA results of a transducer motor structure which uses an air return geometry. The motor structure includes a back plate, an internal magnet, and a top plate. The magnetic flux travels over a relatively long distance, high reluctance path from the OD surface of the top plate to the back plate. The OD surface of the top plate is beveled, to produce a magnetic taper in the high flux density region close to the top plate, where the voice coil (not shown) will travel. FIG. 44 is a Bn graph of this motor structure.

The advantages of this motor structure are its extremely low manufacturing cost, and its light weight. Plus, in some applications, it enables the overall thickness of the transducer to be reduced, because there is no cylindrical cup portion to interfere with other components such as the spider (not shown). The top plate is shown as having a uniform thickness, merely for convenience. Its weight can be significantly reduced by dishing its top surface.

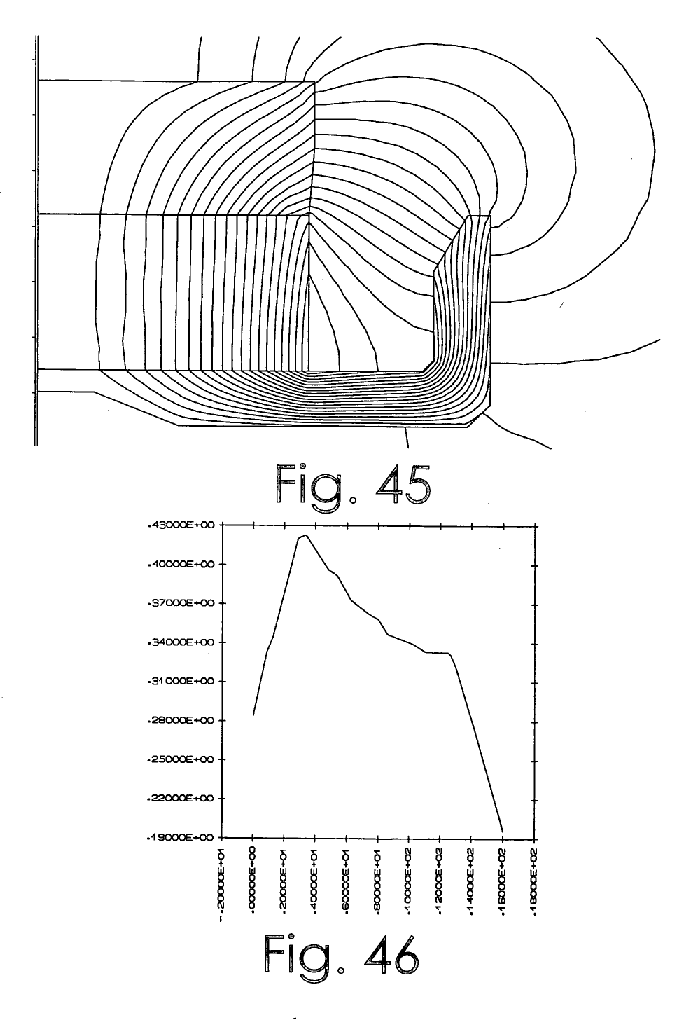

FIG. 45 is a flux plot showing magnetic FEA results of a transducer motor structure which uses an air return geometry. The truncated cylindrical portion of the cup does not extend far enough to create a conventional, short magnetic air gap, but does shorten the distance of the air return path and thereby lower its magnetic reluctance. Advantageously, the inner top lip of this truncated cylindrical portion may itself be beveled, as shown, to shape the magnetic flux density in the high flux density region where the voice coil (not shown) will travel. FIG. 46 is a Bn graph of this motor structure.

### Replaceable Tapering Sleeve

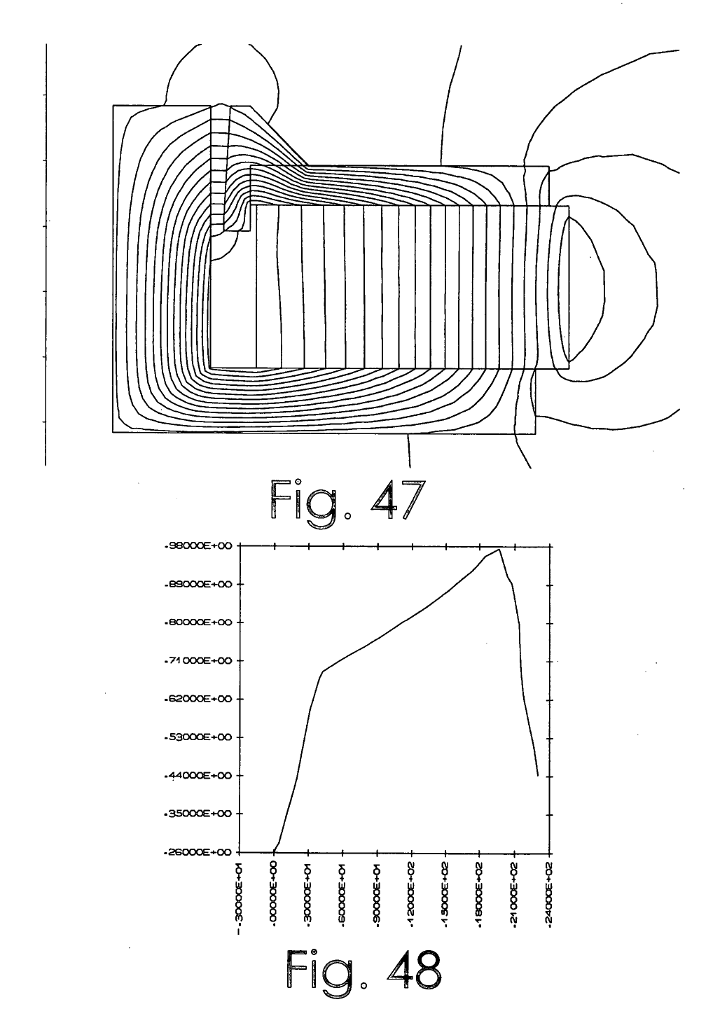

FIG. 47 is a flux plot showing magnetic FEA results of an external magnet geometry transducer motor structure which uses a replaceable tapering sleeve. The sleeve is coupled to the top plate and forms the magnetically tapered air gap with the pole piece. FIG. 48 is a Bn graph of this motor structure. The same technique could, of course, be applied to an internal magnet geometry motor structure.

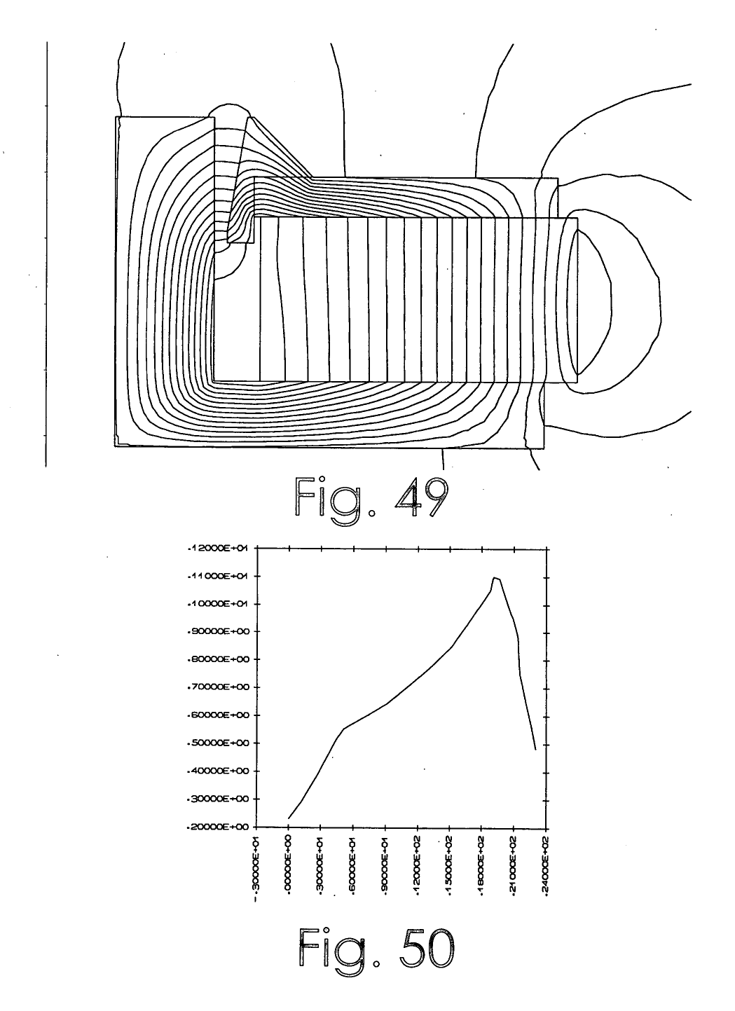

FIG. 49 is a flux plot showing magnetic FEA results of a motor structure which uses the same poleplate, magnet, and top plate as in FIG. 47, but which uses a different tapering sleeve which provides a different magnetic taper in the air gap. FIG. 50 is a Bn graph of this motor structure. FIGS. 48 and 50 demonstrate that significantly different magnetic tapers can be achieved by applying different tapering sleeves to the same basic motor structure.

This enables the manufacturer or user to create multiple different-sounding loudspeakers using a single set of “same sku” motor, frame, and diaphragm assembly parts, with multiple skus of only the tapering sleeve. The sleeve set can range from extremely tapered to non-tapered, and can include some sleeves tapered in one direction and some sleeves tapered in the opposite direction. The sleeve set can also include sleeves of different tapering heights.

In one embodiment, the tapering sleeve is press-fit to the ID of the top plate. In another embodiment, the tapering sleeve is glued to the top plate. In another embodiment, the tapering sleeve and the top plate are threaded together. In another embodiment, the tapering sleeve is bolted to the top plate. In one embodiment, the tapering sleeve is a monolithic unit, while in others, the tapering sleeve is segmented, while in still others, the tapering portion of the sleeve is separate from and coupled to the plate portion of the sleeve.

### CONCLUSION

When one component is said to be “adjacent” another component, it should not be interpreted to mean that there is absolutely nothing between the two components, only that they are in the order indicated.

Both poleplates and cups are yokes, as is the back plate of an axially-charged air return geometry motor. In an external magnet radially-charged air return motor, the inner pole is a yoke. In an internal magnet radially-charged air return motor, the outer cylinder is a yoke.

The high flux density region of an air return motor, in which the voice coil is disposed, can be termed a “magnetic air gap” even though the return path is long. A motor in which the flux return path is via a magnetically conductive yoke which is in close proximity to the top plate so as to create a narrow air gap may be said to have a “low reluctance return path” aka “steel return path” rather than an “air return path”.

In some applications, it may be desirable to achieve a magnetic air gap taper such that the magnetic field strength at the “wide” end of the motor is less than 80% the field strength at the “narrow” end of the motor. In other applications, the “wide” end should be less than 60% as strong as the “narrow” end. In other applications, the “wide” end should be less than 40% as strong as the “narrow” end. And in still other applications, the “wide” end should be less than 10% as strong as the “narrow” end. In each case, a motor with a lesser taper would be considered merely a poorly designed “symmetrical” or non-tapered motor.

The various features illustrated in the figures may be combined in many ways (for example, a transducer motor structure could use a tapering sleeve which is both mechanically tapered and laminated), and should not be interpreted as though limited to the specific embodiments in which they were explained and shown. Those skilled in the art, having the benefit of this disclosure, will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An electromagnetic transducer comprising:
a motor structure having a magnetically tapered air gap, wherein a magnetic taper of the air gap is created by at least one of a top plate and a yoke of the motor structure comprising an at least partially laminated structure; and
a diaphragm assembly coupled to the motor structure and including,
a voice coil disposed in the magnetically tapered magnetic air gap.

2. The electromagnetic transducer of claim 1 wherein the motor structure comprises:
a cup;
a permanent magnet magnetically coupled to the cup; and
a top plate magnetically coupled to the magnet opposite the cup and defining the magnetically tapered air gap with the cup.

3. The electromagnetic transducer of claim 1 wherein the motor structure comprises:
a poleplate;
a permanent magnet magnetically coupled to the poleplate; and
a top plate magnetically coupled to the magnet opposite the poleplate and defining the magnetically tapered air gap with a polepiece of the poleplate.

4. The electromagnetic transducer of claim 1 wherein:
the at least partially laminated structure includes layers of ferromagnetic material and layers of paramagnetic material.

5. The electromagnetic transducer of claim 4 wherein:
at least one of the layers of paramagnetic material comprises a continuous ring of electrically conductive material, whereby that layer serves as a shorting ring reducing inductive heating of the motor structure.

6. The electromagnetic transducer of claim 1 wherein:
the motor structure has an air return geometry.

7. The electromagnetic transducer of claim 6 wherein:
the motor structure includes a truncated cup.

8. The electromagnetic transducer of claim 1 wherein:
the voice coil is underhung.

9. An electromagnetic transducer comprising:
a yoke;
a permanent magnet magnetically coupled to the yoke;
a top plate magnetically coupled to the permanent magnet;
a magnetic air gap defined between the top plate and the yoke; and
a diaphragm assembly including a voice coil disposed in the magnetic air gap;
wherein the magnetic air gap has a tapered magnetic field strength along an axial height of the magnetic air gap; and
wherein at least one of the top plate and a gap-defining portion of the yoke comprises a laminated structure including a plurality of layers of ferromagnetic material and at least one layer of material which is one of paramagnetic and diamagnetic.

10. The electromagnetic transducer of claim 9 wherein:
at least one of the top plate and a gap-defining portion of the yoke comprises a laminated structure including a plurality of layers of ferromagnetic material and at least one layer of air.

11. The electromagnetic transducer of claim 9 wherein:
all of the layers of ferromagnetic material are of a same thickness.

12. The electromagnetic transducer of claim 9 further comprising:
a ferromagnetic cylinder disposed in the magnetic air gap and magnetically coupled to the laminated structure.

13. The electromagnetic transducer of claim 9 wherein:
the laminated structure is only partially laminated, such that at least one of the layers of ferromagnetic material includes a first portion and a second portion, wherein the first portion is thicker than the second portion.

14. The electromagnetic transducer of claim 9 wherein:
a magnetic field strength in a weak end of the tapered magnetic air gap is less than 95% a magnetic field strength in a strong end of the tapered magnetic air gap.

15. The electromagnetic transducer of claim 9 wherein:
a magnetic field strength in a weak end of the tapered magnetic air gap is less than 90% a magnetic field strength in a strong end of the tapered magnetic air gap.

16. The electromagnetic transducer of claim 9 wherein:
a magnetic field strength in a weak end of the tapered magnetic air gap is less than 80% a magnetic field strength in a strong end of the tapered magnetic air gap.

17. The electromagnetic transducer of claim 9 wherein:
a magnetic field strength in a weak end of the tapered magnetic air gap is less than 60% a magnetic field strength in a strong end of the tapered magnetic air gap.

18. The electromagnetic transducer of claim 9 wherein:
a magnetic field strength in a weak end of the tapered magnetic air gap is less than 40% a magnetic field strength in a strong end of the tapered magnetic air gap.

19. The electromagnetic transducer of claim 9 wherein:
the magnetic air gap has a substantially linear taper from a strong end thereof to a weak end thereof.

20. The electromagnetic transducer of claim 14 wherein:
voice coil is underhung.

21. A loudspeaker comprising:
an internal magnet geometry motor structure including,
a cup having a back plate portion and a cylinder portion,
a permanent magnet magnetically coupled to the back plate portion of the cup, and
a top plate magnetically coupled to the permanent magnet opposite the back plate portion of the cup and defining a magnetically tapered magnetic air gap with the cylinder portion of the cup, wherein the top plate comprises a laminated structure including a plurality of steel plates separated at least in part by non-ferrous material; and
a diaphragm assembly including,
a diaphragm,
an underhung voice coil coupled to the diaphragm and disposed within the magnetically tapered magnetic air gap.

22. The loudspeaker of claim 21 wherein, in the laminated structure of the top plate:
at least half of the surface area of opposing faces of at least two adjacent ones of the steel plates are separated by at least 1 mm.

23. The loudspeaker of claim 21 wherein the steel plates are separated by:
a paramagnetic, electrically conductive member disposed between the opposing faces of the at least two adjacent ones of the steel plates.

24. The loudspeaker of claim 21 wherein the steel plates are separated by:
a permanent magnet disposed between the opposing faces of the at least two adjacent ones of the steel plates.

25. The loudspeaker of claim 21 wherein the steel plates are separated by:
at least one of a steel protrusion and a steel disc between the opposing faces of the at least two adjacent ones of the steel plates.
